(19) United States
(12) Patent Application Publication
(10) Pub. No.: US 2022/0318825 A1
(43) Pub. Date: Oct. 6, 2022

(54) Managing Customer Data Collected from Multiple Customer Touchpoints

(71) Applicant: Foot Locker Inc., New York, NY (US)

(72) Inventors: James LEBONITTE, New York, NY (US); Nirmal DAVIS, New York, NY (US); Thangabalaji SWAMYNATHAN, New York, NY (US)

(21) Appl. No.: 17/301,542

(22) Filed: Apr. 6, 2021

(51) Int. Cl. G06Q 30/02; G06F 16/25; G06F 16/2457; G06F 16/242

(52) U.S. Cl. CPC G06Q 30/0201; G06F 16/258; G06F 16/24573; G06F 16/2433

(57) ABSTRACT

The exemplary embodiments relate to managing customer data for an entity that deploys multiple customer touchpoints. The exemplary embodiments include a server that is configured to receive a set of customer data collected at a remote customer touchpoint in a non-standardized format. The set of customer data is then converted into a standardized format. The server also maintains database that includes a collection of unique identifiers (UIDs) that are each unique to a single customer and associated with one or more sets of customer data. The server then determines whether the set of customer data is to be associated with an existing UID or a new UID. When the set of customer data is to be associated with the new UID, the server stores the set of customer data in the database using the standardized format with an association to the new UID.

### BACKGROUND INFORMATION

An entity may deploy multiple customer touchpoints. From the perspective of the entity, each interaction with a prospective or existing customer at a customer touchpoint may generate useful customer data. However, it may be difficult to track a single customer's interactions with the multiple customer touchpoints over time. This may prevent the entity from having an accurate representation of both the behavior of individual customers and the customer base as a whole.

### SUMMARY

According to an exemplary embodiment a method is performed at a server. The method includes receiving a set of customer data collected at a remote customer touchpoint in a non-standardized format used by the remote customer touchpoint. The set of customer data received in the non-standardized format is then converted into a standardized format. The server maintains a database that includes a collection of unique identifiers (UIDs) that are each unique to a single customer and associated with one or more sets of customer data. The server then determines whether the set of customer data is to be associated with an existing UID or a new UID. When the set of customer data is to be associated with the new UID, the server stores the set of customer data in the database. The set of customer data is stored in the standardized format with an association to the new UID.

Further exemplary embodiments relate to a server that includes communication interface configured to send and receive signals over a network connection and a processor configured to perform operations. The operations include receiving a set of customer data collected at a remote customer touchpoint in a non-standardized format used by the remote customer touchpoint. The set of customer data received in the non-standardized format is then converted into a standardized format. The server maintains a database that includes a collection of unique identifiers (UIDs) that are each unique to a single customer and associated with one or more sets of customer data. The server then determines whether the set of customer data is to be associated with an existing UID or a new UID. When the set of customer data is to be associated with the new UID, the server stored the set of customer data in the database. The set of customer data is stored in the standardized format with an association to the new UID.

### BRIEF DESCRIPTION OF THE DRAWINGS

FIG. 1 shows an exemplary arrangement according to various exemplary embodiments.

FIG. 2 shows an example of a portion of a graph data model for a single unique identifier (UID).

FIG. 3 shows an exemplary method for managing customer data collected at multiple different customer touchpoints according to various exemplary embodiments.

### DETAILED DESCRIPTION

The exemplary embodiments may be further understood with reference to the following description and the related appended drawings, wherein like elements are provided with the same reference numerals. The exemplary embodiments relate to managing customer data for an entity that deploys multiple customer touchpoints.

An entity may deploy a wide variety of different types of customer touchpoints. Throughout this description, the term “customer touchpoint” refers to a point where a customer and an entity may exchange information. For example, the entity may sell goods and/or services online and in-store. In this scenario, the entity may deploy customer touchpoints such as, but not limited to, a point of sale (POS) system, an online store and a membership program. Each interaction with a customer at a customer touchpoint may generate data that may be used to better understand customer behavior.

Customer touchpoints may be implemented on different computing platforms. Throughout this description, the terms “platform” and “computing platform” generally refer to a set of hardware, software and/or firmware that facilitates the execution of code. In addition to the customer touchpoints, the entity may also deploy other systems to manage and/or support the operations of the entity. These systems may also be implemented on different computing platforms. Accordingly, the entity may deploy multiple systems running on different computing platforms.

As indicated above, from the perspective of the entity, an interaction with a customer at a customer touchpoint may generate useful customer data. In one aspect, this customer data may be used to better understand a particular customer. In another aspect, customer data from multiple customers may be combined to better understand the customer base as a whole. However, the arrangement of different systems running on different platforms creates obstacles that may prevent the entity from being able to maximize the utility of the customer data. The exemplary embodiments include mechanisms and techniques for managing customer data that are aimed at solving issues specific to an environment that includes multiple customer touchpoints running on different platforms.

Several issues have been identified that are specific to an entity that deploys multiple customer touchpoints on different platforms. One issue relates to tracking the interactions between a single customer and the entity's customer touchpoints over time. For example, it may be difficult to track a single customer's interactions with multiple different customer touchpoints implemented on disparate systems in a timely manner. To provide another example, a single user may have multiple online accounts and appear as multiple distinct customers. These examples and the other issues described throughout this application have a negative impact on the accuracy and usefulness of the customer data.

The exemplary embodiments include techniques for correlating multiple sets of customer data that may be received from different customer touchpoints with a unique ID (UID) corresponding to a single customer. Throughout this description, the terms “customer” and “user” may be used interchangeably and are intended to represent a person (or entity) that may directly interact with a customer touchpoint via an electronic device or indirectly interact with a customer touchpoint via an employee operating an electronic device (e.g., in-store, over the phone, etc.).

In some scenarios, the exemplary mechanism may correlate two separate interactions, each at a different customer touchpoint, with the same UID. Without the UID, this customer data may appear as two separate customers or at least one unknown customer. In another example, the exemplary mechanism may correlate two different online accounts with a single UID. This may indicate that a single user has multiple online accounts. Thus, implementing the UID not only provides a better understanding of the behavior of a single customer but also provide a more accurate representation of the customer base as a whole.

Another issue relates to customer data being available in a timely manner. Generally, the faster that customer data is available to the appropriate employee, the greater the utility of the customer data. Throughout this description, the terms “employee” and “user” may be used interchangeably and are intended to represent a person who works for the entity (or person) that deploys the multiple customer touchpoints.

There are several obstacles, specific to an arrangement that includes multiple customer touchpoints, that prevents customer data from being available in a timely manner. For instance, under conventional circumstances, the entity must continually monitor and process customer data from multiple channels. Further, the data collected by each touchpoint is in a non-standard format selected by whichever computing platform that is implemented by the corresponding system (e.g., POS system, online store, marketing applications, omnichannel commerce software, social media, membership programs, etc.). Other obstacles include these systems storing information in separate locations, the types of available customer touchpoints continually evolving, these systems not being updated in a timely manner or not having the customer data readily available for export and being unable to correlate or condense the customer data due to format differences. Thus, even though an entity may possess or have access to an enormous amount of customer data, the infrastructure required to deploy multiple different types of customer touchpoints prevents customer data from being readily available in a timely manner. The time delay caused by these types of issues may be so great that it prevents certain use cases from being possible.

As will be described in more detail below, some of the exemplary techniques described herein for generating the UID drastically reduce the time and resources needed to have a meaningful understanding of customer behavior. The exemplary techniques described herein may be used in conjunction with other currently implemented techniques for managing customer data from multiple different customer touchpoints, future implementations of techniques for managing customer data from multiple difference customer touchpoints or independently from other techniques for managing customer data from multiple difference customer touchpoints.

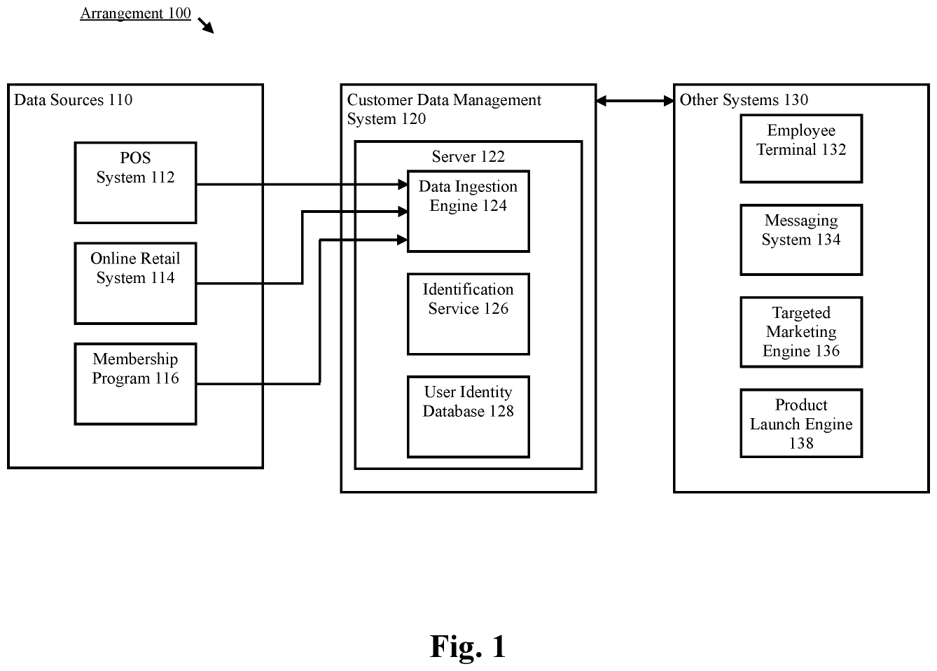

FIG. 1 shows an exemplary arrangement 100 according to various exemplary embodiments. The arrangement 100 includes data sources 110, a customer data management system 120 and other systems 130.

As will be described in more detail below, the data sources 110 represent customer touchpoints and/or any type of system deployed by the entity (or a third party) that is configured to collect customer data. Throughout this description, the term “customer data” may be used to generally describe data generated in response to an interaction between a potential customer and the entity at a customer touchpoint. The data sources 110 may provide sets of customer data to the customer data management system 120. The customer data management system 120 may store customer data using a unique ID (UID) that is associated with a single customer. The data stored at the customer data management system 120 may then be used by the other systems 130 for any of a variety of different purposes.

In the exemplary arrangement 100 the data sources 110 include a POS system 112, an online retail system 114 and a membership program system 116. However, in an actual deployment scenario the data sources may also include, but are not limited to, a hyperlink management system (e.g., clickstream), an omnichannel commerce system, marketing applications, social media applications, a customer relationship management (CRM) system, an e-commerce order management system, etc.

The POS system 112 may be a collection of software and hardware configured to facilitate transactions between the entity and in-store customers. For example, a portion of the POS system 112 may be deployed at a store and used for tasks such as, but not limited to, purchases, returns, inventory, generating receipts, etc. The entity may have multiple stores and warehouses across various geographic regions. Thus, in an actual arrangement, the data sources 110 may include multiple different POS systems running on the same computing platform or on different computing platforms.

The POS system 112 may include one or more processors. In addition, the POS system may include one or more input/output (I/O) devices, one or more displays and one or more communication interfaces to communicate with other systems deployed at the same remote location or region, other systems deployed by the entity via a network connection or systems deployed by a third party via a network connection. However, any reference to the POS system 112 being configured to provide a particular functionality or a particular component being utilized to execute an aspect of the POS system 112 is also only provided for illustrative purposes. The exemplary embodiments may apply to a POS system that is configured for any type of functionality and runs on any appropriate set of electronic components, including cloud implementations.

How the POS system 112 is implemented and the full scope of tasks that may be performed by the POS system 112 is beyond the scope of the exemplary embodiments. Instead, the POS system 112 is provided as an example of a customer touchpoint configured to facilitate transactions between the entity and in-store customers. Thus, the POS system 112 as described herein is used to represent a system that receives information regarding in-store customer interactions.

The online retail system 114 may be a collection of software and hardware configured to facilitate transactions between the entity and remote customers via a network connection. For example, the online retail system 114 may include an online store (e.g., one or more webpages). The entity may host multiple online stores and offer other ways for purchasing goods and/or services online. Thus, in an actual arrangement, the data sources 110 may include multiple different online retail systems running on the same computing platform or on different computing platforms.

The online retail system 114 may include one or more processors. In addition, the online retail system 114 may include one or more I/O devices, a memory arrangement, one or more displays and one or more communication interfaces to communicate with other systems deployed by the entity via a network connection or systems deployed by a third party via a network connection. However, any reference to the online retail system 114 being configured to provide a particular functionality or a particular component being utilized to execute an aspect of the online retail system 114 is also only provided for illustrative purposes. The exemplary embodiments may apply to an online retail system that is configured for any type of functionality and runs on any appropriate set of electronic components, including cloud implementations.

How the online retail system 114 is implemented and the full scope of tasks that may be performed by the online retail system 114 is beyond the scope of the exemplary embodiments. Instead, the online retail system 114 is provided as an example of a customer touchpoint configured to facilitate transactions between the entity and online customers. Thus, the online retail system 114 as described herein is used to represent a system that receives information regarding online customer interactions.

The membership program system 116 may be a collection of software and hardware configured to facilitate interactions between the entity and customer who have signed up to be a part of a membership or loyalty program. For example, the membership program system 116 may manage user accounts enrolled in the membership program, manage customer preferences associated with the user account, etc. The entity may host multiple membership or loyalty programs. Thus, in an actual arrangement, the data sources 110 may include multiple different membership program systems running on the same computing platform or on different computing platforms.

The membership program system 116 may include one or more processors. In addition, the membership program system 116 may include one or more I/O devices, a memory arrangement, one or more displays and one or more communication interfaces to communicate with other systems deployed by the entity via a network connection or systems deployed by a third party via a network connection. However, any reference to the membership program system 116 being configured to provide a particular functionality or a particular component being utilized to execute an aspect of the membership program system 116 is also only provided for illustrative purposes. The exemplary embodiments may apply to a membership program system that is configured for any type of functionality and runs on any appropriate set of electronic components, including cloud implementations.

How the membership program system 116 is implemented and the full scope of tasks that may be performed by the membership program system 116 is beyond the scope of the exemplary embodiments. Instead, the membership program system 116 is provided as an example of a customer touchpoint that interacts with customers in manner that is not exclusively transactional. Thus, the membership program system 116 as described herein is used to represent a system that receives information regarding customer interactions that are not exclusively transactional.

The customer data management system 120 represents a collection of software and hardware that is configured to provide a digital environment that may be accessed and interacted with remotely. In the example of the arrangement 100, the customer data management system 120 may be running on a server 122. Those skilled in the art will understand that the server 122 may be any type of processing component configured to execute software and/or firmware and may also be a cloud implemented virtual environment. In addition, the server 122 may include one or more communication interfaces that are configured to send and receive information over a network connection. In the arrangement 100 only a single server 122 is depicted. However, a person of ordinary skill in the art would understand that an actual customer data management system may be comprised of a collection of software and/or firmware components being executed by one or more hardware components.

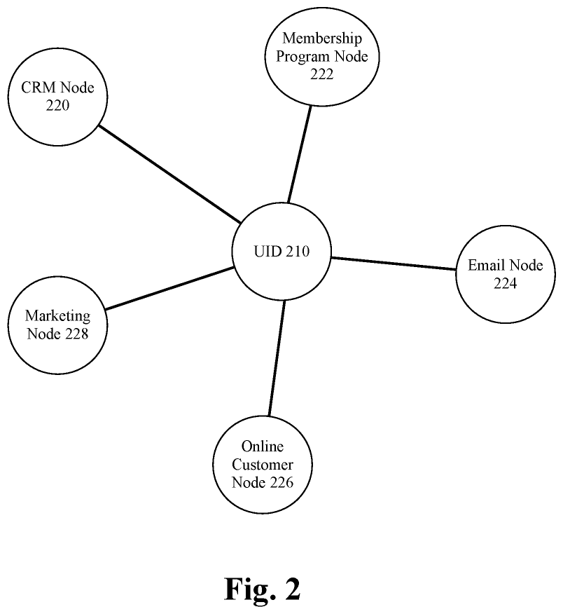

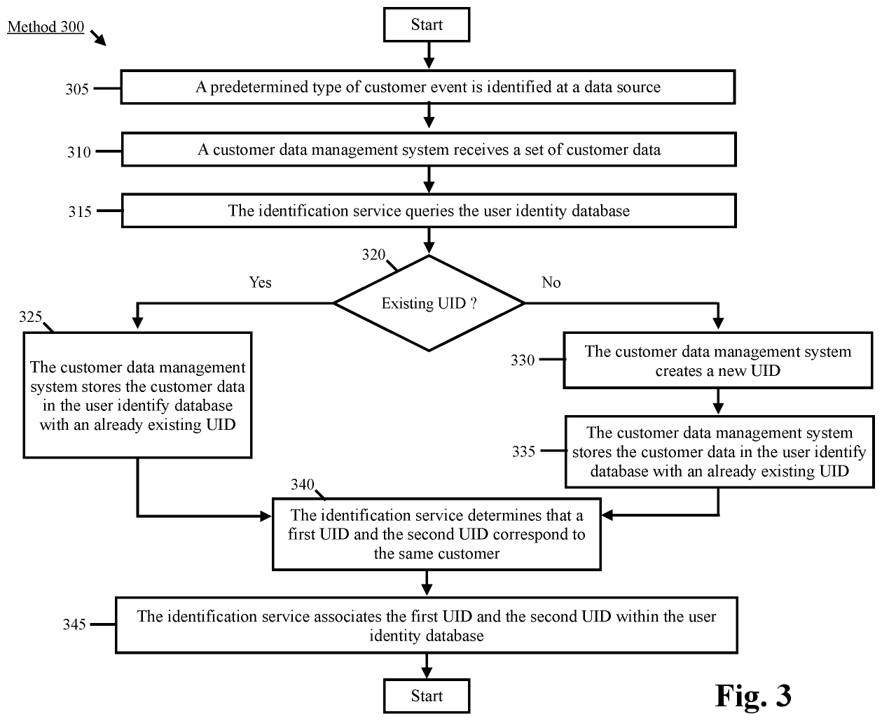

The customer data management system 120 may include a data ingestion engine 124. The data ingestion engine 124 may represent a software module that is connected to each of the remote data sources 110. During operation, the data ingestion engine 124 may receive customer data from the data sources 110. The customer data collected by each of the data sources 110 is in a non-standard format selected by whichever computing platform is implemented by their corresponding system. The data ingestion engine 124 may receive the customer data in the non-standard format and then convert this data into a common format for further processing by the customer data management system 120. Specific examples of this functionality will be provided below with regard to FIGS. 2-3.

The customer data management system 120 may also include an identification service 126 and a user identity database 128. The user identity database 128 may be configured to store UIDs and their associated customer data. The identification service 126 may perform operations related to managing the user identity database 128. As will be described in more detail below, these operations may include determining whether a set of customer data is associated with an existing UID or is to be added to user identity database 128 with a new UID.

From the perspective of the entity, the UIDs are specific to the customer data management system 120 and transparent to the customer. Thus, a UID would not be collected at a customer touchpoint. In addition, a customer may have multiple user accounts with various different systems hosted by the entity. The UID of the customer may be associated with these accounts within the user identify database 128. However, the UID is not intended to replace any of these account identifiers. Instead, the UID uniquely identifies a single customer within the user identity database 128.

The user identify database 128 may implement a graph data model that enables real-time identification by performing look ups across multiple nodes or node types. FIG. 2 shows an example of a portion of a graph data model for a single UID. The format for the graph database is an example of one of the standardized formats that may be implemented by the customer management system 120. In this example, the format for the graph database may be Dgraph. However, in an actual deployment scenario, any appropriate standardized format may be utilized.

FIG. 2 shows a representation of the UID 210 associated with multiple nodes 220-228. In this example, the UID 210 may include the UID, an indication of a date and/or time when the UID was created and an indication of a date and/or time when the UID was last updated.

The customer relationship management (CRM) node 220 represents customer data associated with the UID 210 that is received from a CRM system and/or the POS system 112. In this example, the CRM node 220 may include, but is not limited to, a first name, a last name, a customer ID specific to the CRM system, one or more addresses associated with the customer, a postal code, one or more email addresses, a birthdate, a preferred store, a loyalty status, reward points etc. When converting a set of customer data to be stored in the CRM node 220, the customer data management system 120 may consolidate or update certain information to avoid storing unnecessary or redundant customer data.

The membership program node 222 represents customer data associated with the UID 210 that is received from a system or vendor operating the membership program 116. In this example, the membership program node 222 may include, but is not limited to, a membership ID, a timestamp indicating when the membership account was created, a timestamp indicating when the membership account was last updated, a timestamp indicating when the customer last logged onto their membership program account, an indication of where the user signed up for the membership program (online, in-store, etc.), one or more addresses associated with the customer, a postal code, one or more email addresses, a birthdate, a preferred store, a loyalty status, reward points etc. When converting a set of customer data to be stored in the membership program node 222, the customer data management system 120 may consolidate or update certain information to avoid storing unnecessary or redundant customer data.

The email node 224 represents customer data associated with the UID 210. In this example, the email node 224 may include but is not limited to, one or more email addresses, timestamps indicating when the one or more email addresses interacted with a customer touchpoint, an activity state, etc. When converting a set of customer data to be stored in the email node 224, the customer data management system 120 may consolidate or update certain information to avoid storing unnecessary or redundant customer data.

The online customer node 226 represents customer data associated with the UID 210 that is received from the online retail system 114. In this example, the online customer node 226 may include, but is not limited to, billing information, a customer ID, an order method, a purchase method, one or more timestamps indicating when an online order occurred, one or more timestamps indicating when a product was placed in the cart but never purchased, a customer's communication preferences, an email address, an online account, a membership program account, etc. When converting a set of customer data to be stored in the online customer node 226, the customer data management system 120 may consolidate or update certain information to avoid storing unnecessary or redundant customer data.

The marketing node 228 represents customer data associated with the UID 210 that is received from systems and/or vendors that perform marketing tasks on behalf of the entity. In this example, the marketing node 228 may include, but is not limited to, a timestamp indicating when the customer interacted with an advertisement online (e.g., clicked a hyperlink), cookie data, an indication of whether the advertised product was purchased or offer was utilized, location information, a membership account ID, an activity date, etc. When converting a set of customer data to be stored in the marketing node 228, the customer data management system 120 may consolidate or update certain information to avoid storing unnecessary or redundant customer data.

Returning to the arrangement 100 of FIG. 1, the other systems 130 include an employee terminal 132, a messaging system 134, a targeted marketing system 136 and a product launch engine 138. In some embodiments, the other systems 130 are operated independently from the customer data management system 120. For example, in response to identifying a predetermined condition based on customer data, the customer data management system 120 may be triggered to automatically provide one of the other systems 130 with a message, an alert, a set of customer data, compiled data, derived data or any combination thereof. In other embodiments, one or more of the other systems 130 may be integrated into the customer data management system 120. For example, a client-server mechanism may be implemented to integrate the other systems 130 with the customer data management system 120. However, any reference to a particular type of downstream system or the customer data management system 120 interacting with one of the other systems 130 in a particular manner is merely provided for illustrative purposes. The customer data maintained by the customer data management system 120 may provide the basis for any downstream mechanism to perform subsequent tasks in any appropriate manner.

The employee terminal 132 represents an electronic device that may be used by an employee to directly or indirectly access the data maintained by the customer data management system 120. For example, the employee terminal 132 may represent a smart phone, a desktop computer, a laptop computer, a virtual desktop or any other appropriate type of electronic device that is capable of communicating with a network. All of or a subset of the data maintained by the customer data management system 120 may be available to any number of employees for a wide variety of different purposes. Thus, reference to a single employee terminal 132 is merely for illustrative purposes, the exemplary embodiments are not limited to any particular number of employees or systems accessing the customer data management system 120.

Access to the customer data management system 120 via the employee terminal 132 may be permitted in any appropriate manner. To provide an example, the employee may be assigned a username and password. These credentials may be permitted to access all of the data stored in the customer data management system 120, a portion of the data stored in the customer data management system 120 or none of the data stored in the customer data management system 120. However, the manner in which the customer data management system 120 is accessed by an employee via an employee terminal 132 is beyond the scope of the exemplary embodiments. Permission to access the customer data management system 120 may be based on any appropriate mechanism.

As will be described in more detail below, the employee terminal 132 may be configured to perform a variety of different tasks using the information stored in the customer data management system 120. For instance, the employee terminal 132 may be equipped with software that is configured to display an operational customer health dashboard. This dashboard may represent one or more graphical user interfaces (GUIs) that may be used to retrieve and/or display customer data to the employee.

The messaging system 134 represents a business communication platform that is implemented by the entity. For example, the messaging system 134 may represent an email system, an instant messaging system, internet relay chat (IRC) based mechanisms, direct messaging, etc. Thus, the messaging system 134 represents any type of system implemented by the entity that enables employees to communicate with one another via electronic devices. Further, the entity may implement multiple messaging systems. Thus, reference to a single messaging system 134 is merely provided for illustrative purposes.

As will be described in more detail below, the messaging system 134 may be directly or indirectly connected to the customer data management system 120. When a predetermined condition is identified based on the data stored in the customer data management system 120, the messaging system 134 may be triggered to automatically send a message to a particular user or set of users.

In addition, the targeted marketing engine 136 represents software configured to perform one or more marketing related tasks using the customer data maintained by the customer data management system 120. The product launch engine 138 represents software configured to perform one or more tasks related to providing select customers with the option to purchase products that have limited availability. Specific examples of use cases that may be implemented using the other systems 130 will be provided in detail below after the description of the method 300.

FIG. 3 shows an exemplary method 300 for managing customer data collected at multiple different customer touchpoints according to various exemplary embodiments. The method 300 will be described with regard to the arrangement 100 of FIG. 1.

In 205, a predetermined type of customer event is identified at one of the data sources 110. Throughout this description, the term “customer event” refers to a predetermined type of interaction between the entity and a potential customer via a customer touchpoint. When the predetermined type of customer event is identified, a set of customer data is sent to the customer data management system 120.

To provide an example, each of the data sources 110 may be configured to monitor for a set of predetermined types of customer events. These customer events may include, but are not limited to, performing an online order, performing an in-store purchase, returning an item in-store or via delivery, signing up for the membership program, redeeming membership points, selecting a hyperlink embedded in an e-mail, interacting with a post on a social media platform, etc. Any reference to a customer event being a particular type of interaction is merely provided for illustrative purposes. The exemplary embodiments may apply to any aspect of an interaction between the entity and a potential customer being used as the basis for one of the predetermined types of customer events.

When one of the predetermined types of customer events is identified, a set of customer data may be collected and then provided to the customer data management system 120 (e.g., the data ingestion engine 124). The set of customer data may include at least an indication of the predetermined type of customer event identified at the data source. In some embodiments, the set of customer data may include an indication of multiple types of customer events. In addition, the set of customer data may include, but is not limited to, the data source of origin, an indication of when the interaction occurred and any other information identifying the customer. For instance, depending on the customer touchpoint and the type of interaction, the customer may provide an internet protocol (IP) address, an account identifier, an e-mail address, a social media address, a name, a physical address, a telephone number, shipping information, billing information, membership program status, website cookies or any other piece of information corresponding to the customer or the interaction. Thus, in some embodiments, the customer data may explicitly identify the customer and/or an account the customer has with one or more of the entity's systems. In other embodiments, the customer information may not include data that identifies the customer and/or an account the customer has with one or more of the entity's systems.

The method 300 is described from the perspective of a single instance of a set of customer data traveling from a single data source to the customer data management system 120. However, the operations described with regard to the method 300 may be performed for numerous sets of customer data at approximately the same time. As mentioned above, the utility of the customer data depends on how timely the customer data may be accessible to particular employees or the other systems 130. Thus, the transfer of customer data to the customer data management system 120 may be performed in real-time. This may be achieved by using a programming framework that that connects and/or integrates the customer data management system 120 with each of the data sources 110. This framework may be deployed using a virtual cloud environment.

In 310, the customer data management system 120 receives the set of customer data from the data source. The set of customer data is received in a non-standard format selected by whichever computing platform that the data source is running on. For example, the set of customer data may be received as an application interface (API) call or a structured query language (SQL) query.

As mentioned above, it may be beneficial to process the set of customer data in a timely manner. Thus, in some embodiments, the set of customer data may be converted to a common standardized format in real-time. In other embodiments, batch processing on multiple sets of customer data may be performed on a periodic basis (e.g., every 15 minutes, every hour, every day at a particular time, etc.).

The common standardized format may refer to one or more formats implemented by the customer management system 120. In this example, one common format is the format of the graph database utilized by the user identity database 128. In some embodiments, the graph database may be implemented using Dgraph. Other common formats may include, but are not limited to, a not only structured query language (NoSQL) database and delta data lake tables.

An example of a portion of the graph database is described above with regard to FIG. 2. In addition, the customer data management system 120 may also maintain these other databases and tables. The NoSQL database is a non-tabular database that stores data differently than relational tables. The delta lake tables provide aggregated views of the data in easy formats for data science and analytics use cases. For example, one of the delta lake tables may be configured to lookup a customer and present rows of data that indicate customer touchpoints and details regarding the customer events relative the customer touchpoint. During operation, this table may be queried to identify customer data such as what product the customer purchased, how the customer answered survey questions, whether the customer redeemed points from the loyalty program, etc.

Returning to the method 300, in 315, the identification service 126 queries the user identify database 128. Here, the identification service 126 is determining whether this set of customer data is to be associated with an existing UID already stored in the user identity database 128 or is to be associated with a new UID. The identification service 126 may query the user identify database 128 using the contents of the set customer data after it has been converted to its common format.

In 320, the identification service 126 determines whether the customer data correlates to an existing UID. If the customer data correlates to an existing UID, the method 300 continues to 325.

This determination may be performed on the basis of matching logic that is incorporated into the computer code of the identification service 126. The matching logic may be configured to perform an exact match between portions of this set of customer data and data stored in the user identity database 128. In addition, the matching logic may be configured to match similar instances of data. For example, the matching logic may identify that a shipping address included in the set of customer data and an address that is already stored in the user identity database 128 only differ by an apartment number. Typically, these differences are an attempt to trick the entity into sending multiple products to the same address. Thus, by identifying these similarities the entity may better understand the behavior of a particular customer.

In 325, the set of customer data is stored in the user identify database 128 with the already existing UID. For example, this set of customer data may be incorporated into the graph or nodes associated with the UID identified in 320. This customer data may then be available to the other systems 130. Subsequently, the method 300 continues to 340.

Returning to 320, if the customer information does not correlate to an existing UID, the method 300 continues to 330. In 330, a new UID is created based on the set of customer data. In 335, the customer data the new UID are stored in the user identity database 128. Once this set of customer data has been incorporated into the user identity database 128, it may be used by the other systems 130.

In 340, the identification service 126 determines that a first UID and a second UID stored in the user identity database 128 correspond to a single customer. For example, the identification service 126 may be configured to periodically evaluate the contents of the user identity database 128 searching for UIDs that correspond to the same customer. In this example, the first UID and the second UID represent any UIDs stored in the database.

In 345, the identification service 126 associates the first UID and the second UID within the user identity database 128. For example, in one embodiment, the identification service 126 may connect one or more nodes of the graph associated with the first UID and the second UID. This association will indicate to other systems that these two UIDs correspond to a 126 may single customer. In another embodiment, the identification service 126 may remove one of the UIDs and associate all of the customer data with a single UID.

Subsequently, the method 300 ends. As indicated above, the other systems 130 may then utilize the information stored by the customer management system 120 in a variety of different ways. Specific examples of which will be provided in detail below.

The method 300 describes how a set of customer data customer may be entered into the user identity database 128. In some embodiments, multiple sets of customer data may be processed in a group or a batch. In other embodiments, each set of customer data may be processed in real-time. Thus, regardless of which embodiment is implemented, a scenario may occur in which the customer data management system 120 handles multiple sets of customer data at the same time.

The following examples relate to how downstream employees and systems may access or be made aware of the customer data as it is collected in real-time across the multiple customer touchpoints. These exemplary techniques ensure that customer data is readily available in a timely manner. As indicated above, under conventional circumstances, when a single customer interacts with multiple different customer touchpoints it may be difficult to track the customer's interactions over time because these disparate systems are operated independently from one another and collect data in a non-standard format specific to whichever computing platform is being used by the data sources 110 and/or the customer touchpoints. The exemplary embodiments address these issues by collecting and converting the sets of customer data collected from the customer touchpoints into a standardized format and then storing the sets of customer data using a UID. This allows downstream employees and/or systems to access updated customer data in real-time regardless of the format utilized by the data sources 110 and/or customer touchpoints.

The customer data maintained by the customer data management system 120 may be used in a variety of different ways downstream. In one aspect, the customer data management system 120 enables employees and/or the other systems 130 to evaluate the behavior of one or more customers. Since the customer data is stored in the common format (e.g., graph database, NoSQL database, delta lake tables), it can be easily retrieved by downstream employees and/or systems. The following examples may be implemented using the employee terminal 132 and the operational customer health dashboard mentioned above with regard to the arrangement 100 of FIG. 1 or any other appropriate similar type of mechanism.

In one example, an employee may access the operational customer health dashboard via the employee terminal 132. In some embodiments, the dashboard may be personalized based on the employee's account settings. The employee may interact with the GUIs of the dashboard to retrieve and/or generate key performance indicators (KPIs) based on the customer data stored in the user identity database 128. The KPIs may be specific to a particular aspect of the entity or the entity's ecosystem as a whole.

The user identity database 128 may be used to derive other types of information as well. For example, the user identity database 128 may provide extremely accurate visibility into how the entity is acquiring customers. This may include identifying which customer events are associated with newly created UIDs during a particular time window. In another example, the user identity database 128 may provide insight into how the entity is re-activating customers who have been inactive within the entity's ecosystem. This may include identifying customer events that are associated with a UID that was previously inactive for a particular amount of time. In a further example, the user identity database 128 may provide insight into how the entity is losing customers. This may include identifying customer events that are associated with subsequent inactivity within the entity's ecosystem.

In another example, the user identity database 128 may be used to generate an activity log for a particular time window. The activity log may provide an overview of the activity across the entire ecosystem or may be specific to one or more specific aspects of the ecosystem. For example, the activity log may include each customer event across all of the customer touchpoints for a particular hour and/or day. In another example, the activity log may include each customer event at one or more customer touchpoints over a user selected time window.

Further, the customer data management system 120 may send messages to downstream employees notifying them when a predetermined condition is identified. In other words, instead of the examples provided above in which an employee or system queries the user identity database 128 from the employee terminal 132, the customer data management system 120 may automatically send a message to a particular employee or system in response to certain conditions related to the stored customer data. For example, the customer data management system 120 may be configured to monitor for various predetermined conditions and/or threshold values related to the customer data stored in the user identity database 128. The conditions may be specific to one or more customer touchpoints, a type of customer touchpoint, a UID, a KPI, a data source, an employee, a product, a store or any other appropriate parameter. The customer data management system 120 may then determine whether the predetermined conditions and/or thresholds are satisfied after a new set of customer data is added to the user identity database 128. If a predetermined condition or threshold is satisfied, the customer data management system 120 may send a message to a particular employee or system.

In one example, the automatic messaging may be performed using the operational customer health dashboard. For instance, the GUI of the dashboard may be configured to display an indication that a particular condition or threshold value has been satisfied. This may be achieved by sending a message from the customer data management system 120 to a particular user account, component, remote endpoint, etc. In other embodiments, the customer data management system 120 may trigger the messaging system 134 to send a message to a particular account, component, remote endpoint, etc. In further embodiments, instead of triggering the transmission of a message, the customer data management system 120 may be configured to automatically trigger the start of a downstream process in response to a predetermined condition (or threshold) being satisfied. For example, a downstream system may be triggered to automatically purchase a type and/or quantity of a certain product, send an advertisement to a particular customer, re-route inventory, etc.

In some embodiments, the customer data may be analyzed using store catchment models. Those skilled in the art will understand that a store catchment area refers to a geographical area from which a particular physical store location influences prospective or existing customers. To provide an example, the customer data stored in the user identity database 128 may be analyzed to determine which customers (e.g., UIDs) are going to which stores. In another example, the customer data stored in the user identity database 128 may be analyzed to determine which physical store locations are influencing customer interactions at online customer touchpoints and/or being used by customers to pick up online orders. These models may be used to understand the impact of where a store is located, whether it would be beneficial to add a new store to a particular region or whether it would be beneficial for a store to remain open. In addition, these models may provide insight into the effectiveness of the store's omnichannel capabilities.

In other embodiments, the customer data may be analyzed to predict demand of certain products and/or services that are to be sold by the entity. This predicted demand may then provide the basis for product procurement for a particular store, warehouse and/or region. Inventory management comes with the inherent risk of over or under purchasing of inventory. Since the exemplary embodiments provide an accurate representation of the customer base as a whole, it would be beneficial to consider the customer data stored in the user identity database 128 when establishing an open-to-buy plan for a particular store and/or region.

As indicated above, the customer data maintained by the customer management system 120 may be used by the targeted marketing system 136. For example, the customer data associated with each UID may be analyzed to determine customer attributes such as, but not limited to, brand affinity, a preferred store, a preferred customer touchpoint, a preferred type or customer touchpoint, etc. Targeted ads and/or offers may then be sent to customers using the contact information for each of the UIDs associated with a one or more particular customer attributes.

Similar to the mechanism described above that automatically messages a downstream employee or system based on the customer data, customers may be automatically messaged based on the stored customer data. For example, a message including a targeted advertisement or offer may be transmitted to the email addresses of the UIDs associated with a one or more particular customer attributes in response to identifying a predetermined condition based on the stored customer data. In another example, a remote endpoint associated with a particular UID may be automatically messaged based on identifying a type of customer event. For instance, the customer may be notified that a particular product is available for pickup at a particular location based on identifying a customer event associated with the customer's UID at a different customer touchpoint.

The entity may only want to offer certain products or services to particular customers or may want to limit a single customer to a maximum number of purchases of a particular product or service. For example, the entity may only carry or be permitted to sell a limited quantity of a certain product (e.g., a shoe, a game, a console, a novelty item, clothing, merchandise, etc.). The product launch engine 138 may be configured to perform operations related to determining which customers are to be selected to receive an option to purchase the product.

Under conventional circumstances, a membership program account, email address or some other identifier may be used to determine which customers are to receive an option to purchase a particular product. In this type of scenario, a single user may create multiple online accounts and appear as multiple distinct customers in attempt to exceed the maximum number of purchases per customer. The exemplary embodiments address this issue by having the product launch engine 138 consider the UIDs stored in the user identity database 128 when selecting which customers are to be selected.

To provide an example, the product launch engine 138 may be configured to select multiple customers. Each selected customer is to receive an option to buy (x) amount of product. The UIDs uniquely identify a single customer and thus, may be considered during the selection process to ensure that a single customer does not receive more than (x) options to buy the product. In some embodiments, the product launch engine 138 may intentionally omit UIDs that are associated with multiple online accounts from the selection. In other embodiments, UIDs associated with multiple online accounts may not be permitted from entering the pool of eligible customers. However, the UIDs are transparent to the customers. It may be beneficial for the entity to perform the selection process by limiting UIDs to (x) options without explicitly omitting or denying a particular customer from being selected for the product launch.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows platform, a Mac platform and MAC OS, a Linux based OS, a mobile device having an operating system such as iOS, Android, etc. In a further example, the exemplary embodiments of the above described method may be embodied as a computer program product containing lines of code stored on a computer readable storage medium that may be executed on a processor or microprocessor. The storage medium may be, for example, a local or remote data repository compatible or formatted for use with the above noted operating systems using any storage operation.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed is:

1. A method, comprising:
at a server:
receiving a set of customer data collected at a remote customer touchpoint, wherein the customer data is received in a non-standardized format used by the remote customer touchpoint;
converting the set of customer data received in the non-standardized format into a standardized format, wherein the server maintains a database that includes a collection of unique identifiers (UIDs) that are each unique to a single customer and associated with one or more sets of customer data;
determining whether the set of customer data is to be associated with an existing UID or a new UID; and
when the set of customer data is to be associated with the new UID, storing the set of customer data in the database, wherein the set of customer data is stored in the standardized format with an association to the new UID.

2. The method of claim 1, wherein the set of customer data is transmitted to the server in real-time based on an occurrence of a predetermined type of customer event.

3. The method of claim 1, wherein the non-standardized format includes at least one of application program interface (API) call or a structured query language (SQL) query.

4. The method of claim 1, wherein the standardized format includes at least one of a graph database format, a not only SQL (NoSQL) database format or a delta lake table.

5. The method of claim 1, further comprising:
when the set of customer data is to be associated with the existing UID, storing the set of customer data in the database, wherein the set of customer data is stored in the standardized format with an association to the existing UID.

6. The method of claim 1, further comprising:
determining, after storing the set of customer data, that the new UID and the existing UID are associated with the same customer; and
updating the database to associate the set of customer data with the existing UID.

7. The method of claim 1, wherein the existing UID is associated with multiple online accounts corresponding to the entity that deployed the customer touchpoints.

8. The method of claim 1, further comprising:
automatically transmitting a message to a downstream user in response to identifying a predetermined condition corresponding to the contents of the database, wherein adding the set of customer causes the predetermined condition to be satisfied.

9. The method of claim 1, further comprising:
providing remote access to downstream users over a network so that the database can be queried in real-time through a graphical user interface (GUI) at a remote device.

10. The method of claim 1, wherein a set of online accounts corresponding to the entity are selected to receive an option access a product based on the collection of UIDs stored in the database such that a single UID does not receive more than (X) options.

11. A server, comprising:
a communication interface configured to send and receive signals over a network connection; and
a processor, the processor configured to perform operations, comprising:
receiving a set of customer data collected at a remote customer touchpoint, wherein the customer data is received in a non-standardized format used by the remote customer touchpoint;
converting the set of customer data received in the non-standardized format into a standardized format, wherein the server maintains a database that includes a collection of unique identifiers (UIDs) that are each unique to a single customer and associated with one or more sets of customer data;
determining whether the set of customer data is to be associated with an existing UID or a new UID; and
when the set of customer data is to be associated with the new UID, storing the set of customer data in the database, wherein the set of customer data is stored in the standardized format with an association to the new UID.

12. The server of claim 11, wherein the non-standardized format includes at least one of application program interface (API) call or a structured query language (SQL) query.

13. The server of claim 11, wherein the standardized format includes at least one of a graph database format, a not only SQL (NoSQL) database format or a delta lake table.

14. The server of claim 11, the operations further comprising:
when the set of customer data is to be associated with the existing UID, storing the set of customer data in the database, wherein the set of customer data is stored in the standardized format with an association to the existing UID.

15. The server of claim 11, the operations further comprising:
determining, after storing the set of customer data, that the new UID and the existing UID are associated with the same customer; and
updating the database to associate the set of customer data with the existing UID.

16. The server of claim 11, wherein the existing UID is associated with multiple online accounts corresponding to the entity that deployed the customer touchpoints.

17. The server of claim 11, the operations further comprising:
automatically transmitting a message to a downstream user in response to identifying a predetermined condition corresponding to the contents of the database, wherein adding the set of customer causes the predetermined condition to be satisfied.

18. The server of claim 11, the operations further comprising:
providing remote access to downstream users over the network so that the database can be queried in real-time through a graphical user interface (GUI) at a remote device. cm 19. The server of claim 11, wherein the set of customer data is transmitted to the server in real-time based on an occurrence of a predetermined type of customer event.

20. The server of claim 11, wherein the UID is specific to the database and transparent to the customer.
